(19) United States
(12) Patent Application Publication
(10) Pub. No.: US 2023/0103859 A1
(43) Pub. Date: Apr. 6, 2023

(54) TOOTHBRUSH HEAD

(71) Applicant: SHUMMI ENTERPRISE CO., LTD., Taipei City (TW)

(72) Inventor: CHIA LIN LEE, Taipei City (TW)

(21) Appl. No.: 17/526,269

(22) Filed: Nov. 15, 2021

(30) Foreign Application Priority Data
Oct. 4, 2021 (TW) 110136932

(51) Int. Cl. A46B 5/00; A61C 17/22

(52) U.S. Cl. CPC A46B 5/0095; A61C 17/222; A46B 2200/1066

(57) ABSTRACT

A toothbrush head includes a fixture and a compressing sleeve. The fixture includes a first end and a second end. The first end is provided with a protrusion fastened with the brush head. The second end splits to form a gap that extends toward the first end. The gap has a fastening space fastened with the driving shaft of an electric toothbrush. The compressing sleeve sleeves the outside of the fixture to shrink the gap. The fixture is fastened with the metal driving shafts with various shapes or sizes of electric toothbrushes. As long as the compressing sleeve sleeves the outside of the fixture, the fixture is not loosed. Thus, the toothbrush head is suitable for electric toothbrushes of many brands.

### BACKGROUND OF THE INVENTION

This application claims priority of Application No. 110136932 filed in Taiwan on 4 Oct. 2021 under 35 U.S.C. § 119; the entire contents of all of which are hereby incorporated by reference.

### Field of the Invention

The present invention relates to a toothbrush head, particularly to a toothbrush head suitable for various electric toothbrushes.

### Description of the Related Art

Oral health care is an important part of maintaining good health, which can prevent diseases from entering the mouth. In order to keep the oral cavity clean, an electric toothbrush is used to clean teeth efficiently with its high-frequency rotation speed.

The electric toothbrush includes a handpiece and a disposable brush head. Generally speaking, the top of the handpiece is equipped with a metal driving shaft, which can be inserted into the disposable brush head. When the handpiece is powered on, the metal driving shaft will start to rotate, vibrate or perform other actions, thereby rotating or vibrating the brush head. However, there are many brands of electric toothbrushes. The shapes and sizes of the metal driving shafts of companies are different. Therefore, the disposable brush heads of different brands cannot be assembled with the handpieces of other brands, so that the disposable brush heads and handpieces of various brands cannot be used together. When the user buys an electric toothbrush of a new brand, the brush head of the old brand will no longer be used. If there is a toothbrush head that can be applied to hanpieces of various brands, it will be very convenient for users.

To overcome the abovementioned problems, the present invention provides a toothbrush head, so as to solve the afore-mentioned problems of the prior art.

### SUMMARY OF THE INVENTION

The primary objective of the present invention provides a toothbrush head, which uses a fixture to fasten with the metal driving shafts with various shapes or sizes of electric toothbrushes. As long as a compressing sleeve sleeves the outside of the fixture, the fixture is not loosed. Thus, the toothbrush head is suitable for electric toothbrushes of many brands.

Another objective of the present invention provides a toothbrush head, which uses an elastic component to push against the compressing sleeve, such that the compressing sleeve returns to its original position and compresses the fixture. Thus, it is convenient for the toothbrush head to assemble the driving shaft of the electric toothbrush.

In an embodiment of the present invention, a toothbrush head includes: a brush head; a fixture comprising a first end and a second end, wherein the first end is provided with a protrusion fastened with the brush head, the second end splits to form a gap that extends toward the first end, the gap has a fastening space fastened with the driving shaft of an electric toothbrush; and a compressing sleeve sleeving outside of the fixture to shrink the gap.

In an embodiment of the present invention, the protrusion is provided with threads, the brush head is provided with screw teeth therein, and the screw teeth are screwed to the threads to assemble the brush head and the protrusion.

In an embodiment of the present invention, the compressing sleeve sleeves the fixture from the first end and pushes toward the second end.

In an embodiment of the present invention, the compressing sleeve is pushed toward the second end when the brush head is assembled with the protrusion.

In an embodiment of the present invention, the second end of the fixture is peripherally provided with a position limiting portion that prevents the compressing sleeve from exceeding the second end.

In an embodiment of the present invention, the toothbrush head further includes an elastic component arranged between the compressing sleeve and the fixture, the interior of the compressing sleeve has a second position limiting portion, an end of the elastic component pushes against the second position limiting portion of the compressing sleeve, and another end of the elastic component pushes against the brush head.

In an embodiment of the present invention, the elastic component is compressed when a force pushes the compressing sleeve toward the first end of the fixture, and the elastic component returns to its original shape and pushes against the second position limiting portion to force the compressing sleeve to return to its original position when the force stops pushing the compressing sleeve.

In an embodiment of the present invention, the elastic component is a spring.

Below, the embodiments are described in detail in cooperation with the drawings to make easily understood the technical contents, characteristics and accomplishments of the present invention.

### BRIEF DESCRIPTION OF THE DRAWINGS

FIG. 1 is a perspective view of a toothbrush head according to an embodiment of the present invention;

FIG. 2 is an exploded view of a toothbrush head according to an embodiment of the present invention;

FIGS. 3-7 are cross-sectional views of the steps of assembling a toothbrush head and a driving shaft according to an embodiment of the present invention;

FIG. 8 is an exploded view of a toothbrush head according to another embodiment of the present invention; and

FIGS. 9-12 are cross-sectional views of the steps of assembling a toothbrush head and a driving shaft according to another embodiment of the present invention.

### DETAILED DESCRIPTION OF THE INVENTION

The present invention provides a toothbrush head suitable for various shapes or sizes of electric toothbrushes of different brands. The toothbrush head can be fastened with a metal driving shaft to assemble the handpiece of the electric toothbrush.

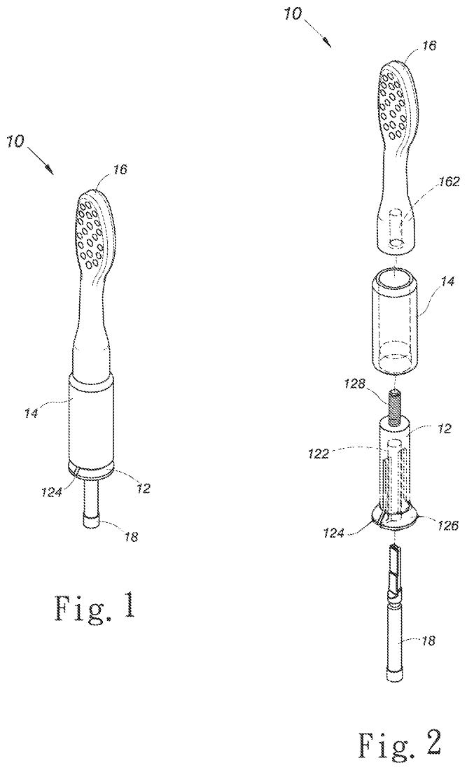

FIG. 1 is a perspective view of a toothbrush head according to an embodiment of the present invention. FIG. 2 is an exploded view of a toothbrush head according to an embodiment of the present invention. Referring to FIG. 1 and FIG. 2, a toothbrush head 10 of the present invention includes a fixture 12 and a compressing sleeve 14. The fixture 12 includes a first end and a second end opposite to the first end. As shown in FIG. 2, the first end is the top of the fixture 12 and the second end is the bottom of the fixture 12. The first end is provided with a protrusion 128 which can be inserted into a brush head 16. The brush head 16 is provided with a fixing portion 162 therein. The fixing portion 162 fastens the protrusion 128 with the brush head 16. The middle of the second end splits to form a gap 124 that extends toward the first end. The gap 124 has a fastening space 122 to be fastened with a driving shaft 18 of an electric toothbrush. The compressing sleeve 14 sleeves the outside of the fixture 12. Specifically, the compressing sleeve 14 sleeves the fixture 12 from the first end and pushes toward the second end to shrink the gap 124. Thus, the fixture 12 can tightly clamp the driving shaft 18 to assemble the toothbrush head 10 and the electric toothbrush.

When the brush head 16 is assembled with the protrusion 128 of the fixture 12, the compressing sleeve 14 is pushed toward the second end of the fixture 12. In an embodiment, the protrusion 128 is provided with threads, the inner wall of the fixing portion 162 is provided with screw teeth, and the screw teeth are screwed to the threads to assemble the brush head 16 and the protrusion 128. As a result, the brush head 16 rotates and pushes the compressing sleeve 14 toward the second end of the fixture 12.

Besides, the second end of the fixture 12 is peripherally provided with a position limiting portion 126 that prevents the compressing sleeve 14 from exceeding the second end. A user needs to push the compressing sleeve 14 to the position limiting portion 126 to achieve the best tightness.

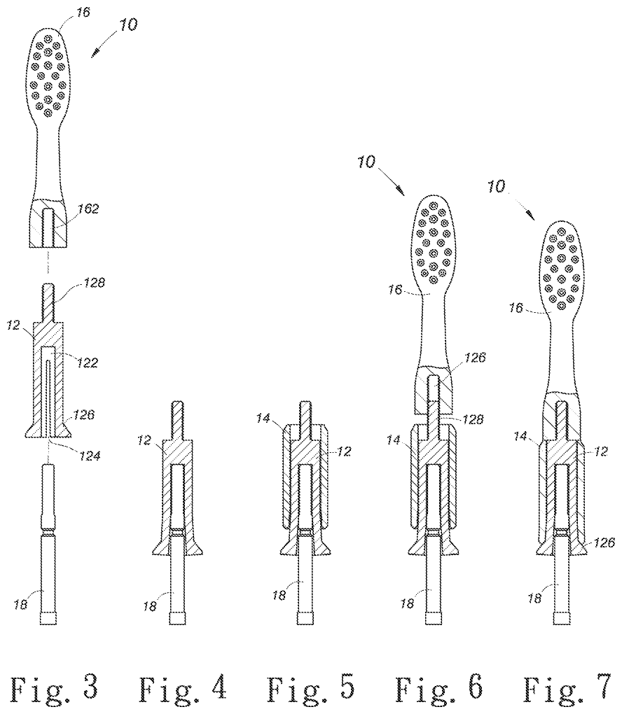

FIGS. 3-7 are cross-sectional views of the steps of assembling a toothbrush head and a driving shaft according to an embodiment of the present invention. FIG. 3 is a diagram schematically showing that the toothbrush head and the driving shaft are not assembled. As shown in FIG. 3, the brush head 16, the fixture 12, and the driving shaft 18 separate from each other. The fixture 12 includes a middle gap 124 and a position limiting portion at the second end. As shown in FIG. 4, the driving shaft 18 is inserted into the fixture 12. As shown in FIG. 5, the compressing sleeve 14 sleeves the fixture 12 from the first end. As shown in FIG. 6, the brush head 16 downwards from above the fixture 12, such that the fixing portion 162 of the brush head 16 is fastened with or screwed to the protrusion 128 of the fixture 12. Alternatively, the fixing portion 162 of the brush head 16 is fixed to the protrusion 128 of the fixture 12 in other manners. The brush head 16 pushes against the compressing sleeve 14, such that the compressing sleeve 14 moves downward. As shown in FIG. 7, the bottom of the compressing sleeve 14 pushes against the position limiting portion 126 of the fixture 12 to complete the assembly of the brush head 16, the toothbrush head 10, and the driving shaft 18. In the embodiment, the brush head 16 and the compressing sleeve 14 need to be disassembled in order to assemble the driving shaft 18 of the electric toothbrush.

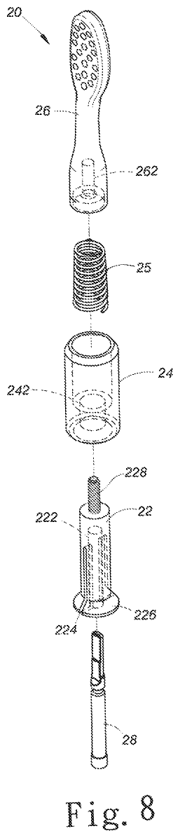

FIG. 8 is an exploded view of a toothbrush head according to another embodiment of the present invention. In the embodiment, a toothbrush head 20 of the present invention includes a fixture 22, a compressing sleeve 24, and an elastic component 25. The fixture 22 includes a first end and a second end. As shown in FIG. 8, the first end is the top of the fixture 22 and the second end is the bottom of the fixture 22. The first end is provided with a protrusion 228 which can be inserted into a brush head 26. The brush head 26 is provided with a fixing portion 262 therein. The fixing portion 262 fastens the protrusion 228 with the brush head 26. The middle of the second end splits to form a gap 224 that extends toward the first end. The gap 224 has a fastening space 222 to be fastened with a driving shaft 28 of an electric toothbrush. The compressing sleeve 24 sleeves the outside of the fixture 22. Specifically, the compressing sleeve 24 sleeves the fixture 12 from the first end and pushes toward the second end to shrink the gap 224. Thus, the fixture 22 can tightly clamp the driving shaft 28 to assemble the toothbrush head 20 and the electric toothbrush. The elastic component 25 is arranged between the compressing sleeve 24 and the fixture 22. The interior of the compressing sleeve 24 has a second position limiting portion 242. An end of the elastic component 25 pushes against the second position limiting portion 242 of the compressing sleeve 24, and another end of the elastic component 25 pushes against the brush head 26. The elastic component 25 is a spring.

During assembly, the compressing sleeve 24 sleeves the fixture 12 from the first end, such that the bottom of the compressing sleeve 24 pushes against the first position limiting portion 226 at the second end of the fixture 22. Then, the elastic component 24 is inserted between the fixture 22 and the compressing sleeve 24. An end of the elastic component 25 pushes against the second position limiting portion 242 of the compressing sleeve 24, and another end of the elastic component 25 exceeds the compressing sleeve 24. The length where the elastic component 25 exceeds the compressing sleeve 24 does not exceed the protrusion 228 of the fixture 22. Then, the fixture 22 is assembled with the brush head 26. In an embodiment, the protrusion 228 is provided with threads, the inner wall of the fixing portion 262 is provided with screw teeth, and the screw teeth are screwed to the threads to assemble the brush head 26 and the protrusion 228. When the brush head 26 pushes against and enters into the compressing sleeve 24 for a short distance, the brush head 26 compresses the exposed elastic component 25 into the compressing sleeve 24. The complete assembly is shown in FIG. 1.

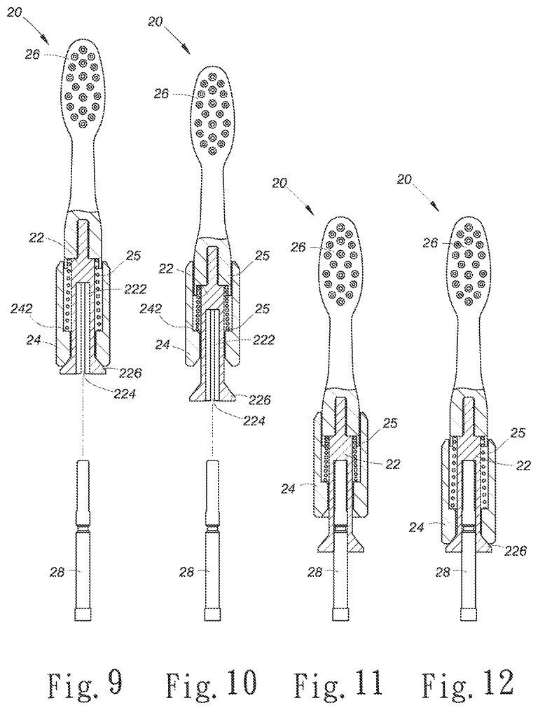

In the embodiment of FIG. 8, the toothbrush head 20 is a set, which is different from the embodiment of FIG. 2. In the embodiment of FIG. 8, the toothbrush head 20 is assembled with the driving shaft 28 of the electric toothbrush without disassembling the brush head 26. FIGS. 9-12 are cross-sectional views of the steps of assembling a toothbrush head and a driving shaft according to another embodiment of the present invention. As shown in FIG. 9, the assembled toothbrush head 20 is prepared. As shown in FIG. 10, the pressing sleeve 24 is forced to move upward along the fixture 22. At this time, the elastic component 25 is compressed by the second position limiting portion 242 of the sleeve 24 and the brush head 26. Since the pressing sleeve 24 moves upward, the gap 224 of the fixture 22 is expanded. As shown in FIG. 11, the driving shaft 28 is inserted into the gap 224 of the fixture 22. As shown in FIG. 12, When the compressing sleeve 24 is not forced, the elastic component 25 automatically returns to its original shape and pushes against the second position limiting portion 242 of the compressing sleeve 24, such that the compressing sleeve 24 returns to its original position to push against the first position limiting portion 226 and tightly clamp the driving shaft 28.

In conclusion, the toothbrush head of the present invention has two embodiments. The fixture and the compressing sleeve clamp the driving shafts with various shapes or sizes of electric toothbrushes of different brands to have universal features. In addition, the present invention arranges an elastic component between the fixture and the compressing sleeve, such that the compressing sleeve can automatically return to its original position. Thus, the toothbrush head of the present invention is a set. The toothbrush head is assembled with the driving shaft of the electric toothbrush without disassembling the brush head. The toothbrush head has practicality.

The embodiments described above are only to exemplify the present invention but not to limit the scope of the present invention. Therefore, any equivalent modification or variation according to the shapes, structures, features, or spirit disclosed by the present invention is to be also included within the scope of the present invention.

What is claimed is:

1. A toothbrush head, fastened with a driving shaft of an electric toothbrush, comprising:
a brush head;
a fixture comprising a first end and a second end, wherein the first end is provided with a protrusion fastened with the brush head, the second end splits to form a gap that extends toward the first end, the gap has a fastening space fastened with the driving shaft; and
a compressing sleeve sleeving outside of the fixture to shrink the gap.

2. The toothbrush head according to claim 1, wherein the protrusion is provided with threads, the brush head is provided with screw teeth therein, and the screw teeth are screwed to the threads to assemble the brush head and the protrusion.

3. The toothbrush head according to claim 1, wherein the compressing sleeve sleeves the fixture from the first end and pushes toward the second end.

4. The toothbrush head according to claim 3, wherein the compressing sleeve is pushed toward the second end when the brush head is assembled with the protrusion.

5. The toothbrush head according to claim 1, wherein the second end of the fixture is peripherally provided with a position limiting portion that prevents the compressing sleeve from exceeding the second end.

6. The toothbrush head according to claim 1, further comprising an elastic component arranged between the compressing sleeve and the fixture, an interior of the compressing sleeve has a second position limiting portion, an end of the elastic component pushes against the second position limiting portion of the compressing sleeve, and another end of the elastic component pushes against the brush head.

7. The toothbrush head according to claim 6, wherein the elastic component is compressed when a force pushes the compressing sleeve toward the first end of the fixture, and the elastic component returns to its original shape and pushes against the second position limiting portion to force the compressing sleeve to return to its original position when the force stops pushing the compressing sleeve.

8. The toothbrush head according to claim 6, wherein the elastic component is a spring.
